(19) United States
(12) Patent Application Publication
(10) Pub. No.: US 2008/0206517 A1
(43) Pub. Date: Aug. 28, 2008

(54) Fabric articles and methods of making such articles

(75) Inventor: Joseph Meir Meizelman, Zug (CH)

Correspondence Address: Martin D. Moynihan;PRTSI, Inc., P.O. Box 16446, Arlington, VA, 22215, US

(73) Assignee: Bright Technologies Corp. Inc., Zug (CH)

(21) Appl. No.: 12/071,518

(22) Filed: Feb. 21, 2008

Related U.S. Application Data
(60) Provisional application No. 60/903,313, filed on Feb. 26, 2007.

(51) Int. Cl. B32B 3/00; D04H 13/00; D06C 27/00

(52) U.S. Cl. 428/141; 428/195.1; 442/334; 26/18.5

(57) ABSTRACT

A fabric article, and method of making same, useful as a wet-wipe includes an absorbent fabric sheet moistened with a preselected wiping liquid, characterized in that the absorbent fabric sheet is in a compressed, flattened condition. Also described is a fabric article, and method of making same, which includes a sheet of a non-woven fabric, preferably a spunbond fabric which has undergone a needlepoint treatment to increase its absorbency and to improve feel (i.e., making it smoother to touch), and a compression treatment to decrease its volume.

### RELATED APPLICATION

This Application claims the benefit of U.S. Provisional Patent Application No. 60/903,313 filed on Feb. 26, 2007, the contents of which are hereby incorporated by reference.

### FIELD AND BACKGROUND OF THE INVENTION

The present invention relates to fabric articles, and particularly to such articles useful as wet-wipes, and also to methods of making such articles.

A wide variety of fabric articles are presently commercially available made of absorbent fabric sheets which have been compressed so as to be in a flattened reduced-volume condition. Examples of such articles include towels, diapers, masks, sanitary napkins, and the like. Such articles are generally compressed by applying pressure and/or a vacuum thereto.

Also commercially available are a wide variety of wet-wipes, comprising an absorbent fabric sheet moistened with a preselected wiping liquid. Examples of such wet-wipes include hand-cleaning wipes, disinfecting wipes, window and glass wipes, make-up remover wipes, silver-leaning wipes, shoe-cleaning wipes, etc.

Insofar as we are aware, however, it is not previously known to produce wet-wipes which have been compressed in order to reduce their volume.

### OBJECTS AND BRIEF SUMMARY OF THE PRESENT INVENTION

One object of the present invention is to provide a fabric article useful as a wet-wipe, and also to a method of making such article, which is in a compressed flattened condition so as to provide the advantages of both of the above two types of fabric articles.

Another object of the present invention is to provide a non-woven fabric article having a smooth touch with increased absorbency, and thereby making it particularly useful for producing wet-wipes.

According to one aspect of the present invention, there is provided a fabric article useful as a wet-wipe comprising an absorbent fabric sheet moistened with a preselected wiping liquid, characterized in that the absorbent fabric sheet is in a compressed flattened condition. In one described preferred embodiment, the absorbent fabric sheet is a woven fabric, such as cotton; preferably, however, the absorbent fabric sheet is a non-woven fabric, such as made by a spunbond process.

According to another aspect of the present invention, there is provided a fabric article comprising a sheet of a non-woven fabric, such as a spunlace fabric, but preferably a spunbond fabric which has undergone a needlepunch treatment to improve its absorbency and feel, i.e., smoother to the touch. In a described preferred embodiment, the sheet of a spunbond fabric has undergone a compression treatment after the needlepunch treatment to decrease its volume. The sheet is then moistened with a wiping liquid, i.e., after the compression treatment, to enable the sheet to be used as a wet-wipe.

Spunbond fabrics are produced by depositing extruded, spun filaments onto a collecting belt in a uniform random manner followed by bonding the fibers. The fibers are separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used s thermal binding fibers. Polyethylene or random ethylene-propylene copolymers are used as low melting bond sites. Spunbond products are employed in carpet backing, geotextiles, and disposable medical/hygiene products. Since the fabric production is combined with fiber production, the process is generally more economical than when using staple fiber to make non-woven fabrics.

Spunlace fabrics are produced by a hydroentanglement process, which is a mechanical bonding process whereby fibers are entangled by means of high pressure water jets. Spunlace is a highly versatile process as it can be used to produce non-wovens with a broad range of end-user properties. These differences are achieved through the availability of a wide range of fibers as well as the possibility of adjusting production parameters. The advantage of the hydroentanglement processes is that it can be used to combine conventionally formed webs with melt-blown, spunbound webs, other textiles and scrims to achieve a combination of properties that cannot be realized through a single web.

In needlepunching, webs are mechanically bound to form a fabric. This is done by puncturing the web with an array of barbed needles that carry tufts of the web's own fibers in a vertical direction through the web. The result is a low-loft, high-density product. Webs of different characteristics can be needled together to produce a gradation of properties difficult to achieve by other means. Needlepunch is especially gaining momentum in the automotive market where, thanks to its moldability and ease of trimming, it continues to replace woven materials. Needlepunch is currently found in car package trays, headliners, trunk liners, carpeting and padding.

As indicated above, the combination of the non-woven process, particularly the spunbond process, with the needlepunch treatment, has been found to increase the absorbency and to improve the feel or touch of the produced absorbent fabric sheet, thereby making such fabrics particularly useful for wet-wipes.

According to a further aspect of the present invention, there is provided a method of making a fabric article useful in a wet-wipe, comprising the steps of compressing an absorbent fabric sheet to a flat condition, and moistening the fabric sheet with a selected wiping liquid. In a described preferred embodiment, the compression step is performed before the moistening step. In addition, the absorbent fabric sheet is a non-woven fabric, preferably one produced by a spunbond process, followed by a needlepunch treatment to increase its absorbency and to improve its feel or touch.

According to a further aspect of the present invention, therefore, there is provided a method of making a fabric article, comprising: producing an absorbent fabric sheet by a spunbond process; and subjecting the absorbent fabric sheet, after produced by the spunbond process, to a needlepunch treatment to increase its absorbency and to improve its feel.

According to further features in the described preferred embodiment, after the needlepunch treatment, the absorbent fabric sheet is subjected to a compression treatment to flatten the sheet and reduce its volume. In addition, after the compression treatment, the absorbent fabric sheet is subjected to a moistening treatment in which it is moistened by a selected wiping liquid.

In the described preferred embodiment, the moistening treatment is effected by dripping the selected wiping liquid onto the flattened absorbent fabric sheet.

Further features and advantages of the invention will be apparent from the description below.

### BRIEF DESCRIPTION OF THE DRAWINGS

The invention is herein described, by way of example only, with reference to the accompanying drawings, wherein:

FIGS. 1-4 are block diagrams illustrating three methods of making wet-wipes in accordance with the present invention;

FIG. 5 illustrates the spunbond process in the method of FIG. 4;

FIG. 6 illustrates the needlepunching process in the method of FIG. 4;

and FIG. 7 diagrammatically illustrates the moistening process in the method of FIG. 4.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

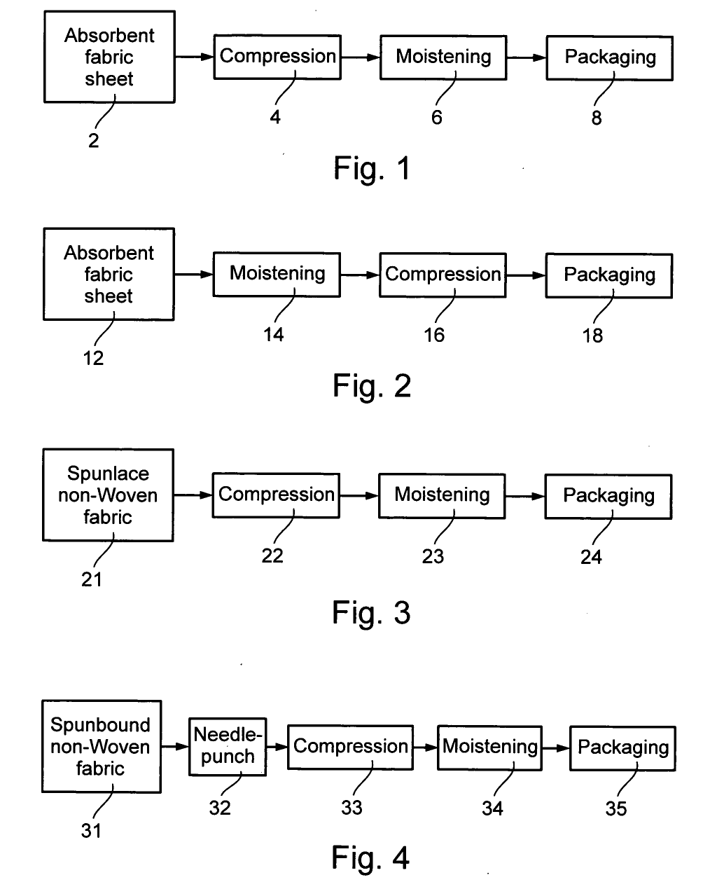

FIG. 1 is a block diagram illustrating one method of making wet-wipes in accordance with the present invention. As shown in FIG. 1, such a method involves first producing or providing an absorbent fabric sheet 2; compressing the absorbent fabric as shown at 4 in order to flatten it and to reduce its volume; then moistening the fabric sheet, as shown at 6, with a selected wiping liquid; and finally packaging the moistened flattened sheet as shown at 8.

In its broadest aspects, the absorbent fabric sheet 2 may be a woven fabric, such as woven cotton. Preferably, as will be described below particularly with respect to FIGS. 3-6, it is a non-woven fabric. Many non-woven fabrics are known, such as those produced by spunlacing, spunbonding and needlepunching, as briefly described above and as included in the preferred embodiment described below with respect to FIGS. 4-7.

The compression step indicated at 4 in FIG. 1 may be effected by a conventional mechanical press which flattens the fabric and reduces its volume. The moistening step 6 of FIG. 1 is preferably a dripping process, as described below with respect to FIG. 7. The packaging step 8 in FIG. 1 may be any conventional packaging technique, for packaging individual wet-wipes in soft or hard packages, or a plurality of such wet-wipes in soft or hard packages.

FIG. 2 illustrates a process which is very similar to that of FIG. 1, except that the compression step (4, FIG. 1) is effected after the moistening step, rather than before the moistening step as in FIG. 1. Otherwise, the process is basically the same as in FIG. 1, including the step of providing or producing the absorbent fabric sheet 12; moistening it with the wiper liquid 14; compressing it to a flattened and reduced-volume condition 16; and packaging the so-produced wet-wipes.

The process of FIG. 1 would normally be preferable to that of FIG. 2, since compressing the fabric sheet before the moistening step enables the sheet to be compressed to a greater extent and to reduce its volume to a greater extent.

FIG. 3 illustrates a process similar to that of FIG. 1, except that the fabric sheet, therein designated 21, is a non-woven fabric produced by the spunlace process, as briefly described above. The remainder of the process, including the compression step 22, the moistening step 23, and the packaging step 24, are the same as in FIG. 1.

FIG. 4 is a block diagram illustrating the preferred method of producing the wet-wipes in accordance with the present invention.

Thus, as shown in FIG. 4, the absorbent fabric sheet is first produced by spun bonding process, as shown at 31, and is then subjected to a needlepunch treatment process, as shown at 32. This has been found to produce an absorbent fabric sheet of better absorbency and smoother touch, such as to make it particularly useful for producing wet-wipes in accordance with the present invention.

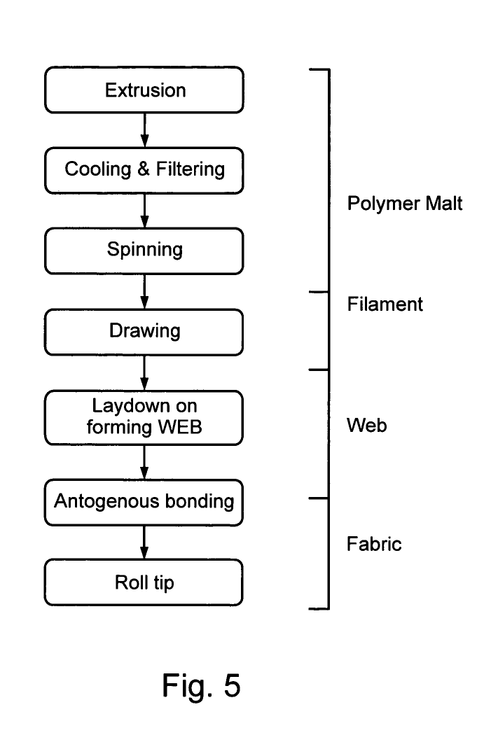

The spin bonding process 31 of FIG. 4 is briefly described above, and is more particularly illustrated in the block diagram of FIG. 5. Since this is a well-known process, any further information that may be desired is available in the published literature.

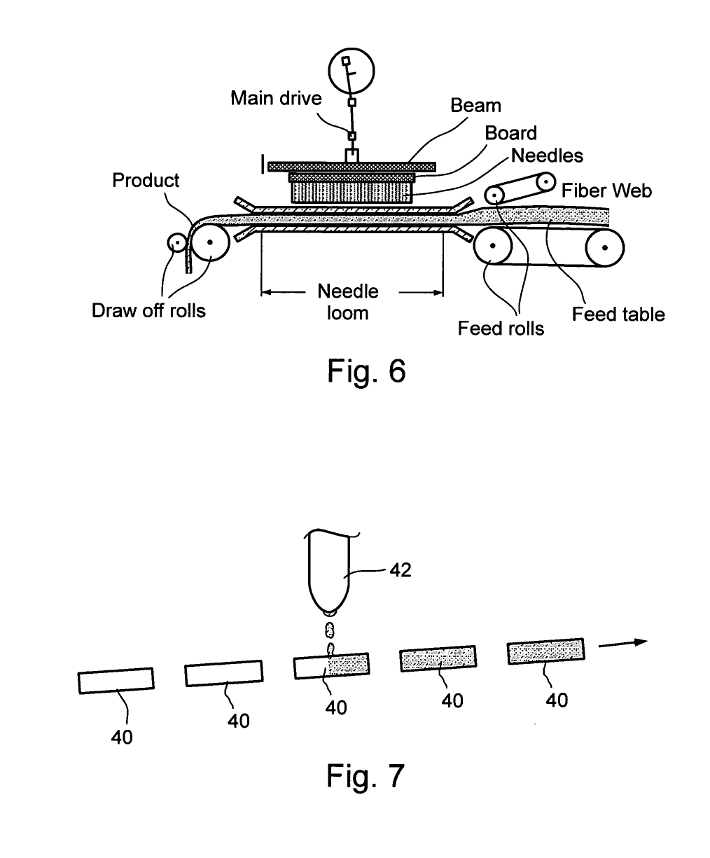

The needlepunching process of block 32 in FIG. 4 is more particularly illustrated in FIG. 6. Since this is also a well known process, further information as to this process is available in the published literature.

Moistening step 34 in FIG. 4 is preferably performed according to the diagram illustrated in FIG. 7, namely by a dripping process. Thus, as shown in FIG. 7, the absorbent fabric sheets 40, after being produced by the spun-bonding 31, the needlepunching step 32 and the compression step 33 of FIG. 4, are fed past a nozzle 42 filled with the selected wiping liquid, which liquid is permitted to drip or trickle onto the fabric sheets at a rate according to the quantity of the wiping liquid to be received.

The invention is thus useful for producing a wide variety of absorbent fabric sheets, and particularly those moistened with a preselected wiping liquid, such as the fabric sheets and wet-wipes referred to above. The invention, however, is particularly useful for producing compressed wet-masked sheets or other woven or non-woven materials which are cut into special configurations, as well as medical bandage pads and other medical products.

In addition, while the needlepunching treatment has been described with respect to a spunbond fabric, it could also be used in other types of fabrics to increase the porosity and improve the feel or touch of the fabric.

Therefore, while the invention has been described with respect to several preferred embodiments, it will appreciated that these are set forth merely for purposes of example, and that many other variations, modification and applications of the invention may be made.

What is claimed is:

1. A fabric article useful as a wet-wipe, comprising an absorbent fabric sheet moistened with a preselected wiping liquid, characterized in that said absorbent fabric sheet is in a compressed flattened condition.

2. The fabric article according to claim 1, wherein said absorbent fabric sheet is a woven fabric.

3. The fabric article according to claim 1, wherein said absorbent fabric sheet is a non-woven fabric.

4. The fabric article according to claim 1, wherein said non-woven fabric is a spunlace fabric.

5. The fabric article according to claim 4, wherein said non-woven fabric is a spunbond fabric.

6. The fabric article according to claim 5, wherein said spunbond fabric has undergone a needlepunch treatment before being compressed, flattened and moistened with said preselected wiping liquid.

7. The fabric article according to claim 1, wherein said fabric article is individually packaged.

8. The fabric article according to claim 1, wherein a plurality of said fabric articles are included in a common package.

9. A fabric article comprising:
a sheet of a spunbond fabric which has undergone a needlepunch treatment to increase its absorbency and to improve its feel.

10. The fabric article according to claim 9, wherein said sheet of a spunbond fabric has undergone a compression treatment after said needlepoint treatment to decrease its volume.

11. The fabric article according to claim 10, wherein said sheet has been moistened with a wiping liquid after said compression treatment.

12. A method of making a fabric article useful as a wet-wipe, comprising the steps of compressing an absorbent fabric sheet to a flat condition, and moistening the fabric sheet with a selected wiping liquid.

13. The method according to claim 12, wherein said compression step is performed before said moistening step.

14. The method according to claim 12, wherein said compression step is performed after said moistening step.

15. The method according to claim 12, wherein said absorbent fabric sheet is a woven fabric.

16. The method according to claim 12, wherein said absorbent fabric sheet is a non-woven fabric.

17. The method according to claim 16, wherein said non-woven fabric is produced by a spunlace process.

18. The fabric article according to claim 16, wherein said non-woven fabric is produced by a spunbond process.

19. The method according to claim 16, wherein said non-woven fabric is subjected to a needlepunch treatment to increase its absorbency and to improve its touch.

20. A method of making a fabric article, comprising:
producing an absorbent fabric sheet by a spunbond process;
and subjecting said absorbent fabric sheet, after produced by the spunbond process, to a needlepunch treatment to increase its absorbency and to improve its feel.

21. The method to claim 20, wherein, after said needlepunch treatment, said absorbent fabric sheet is subjected to a compression treatment to flatten the sheet and reduce its volume.

22. The method according to claim 21, wherein, after said compression treatment, said absorbent fabric sheet is subjected to a moistening treatment in which it is moistened by a selected wiping liquid.

23. The method according to claim 22, wherein said moistening treatment is effected by dripping the selected wiping liquid onto the flattened absorbent fabric sheet.
